(19) United States
(12) Patent Application Publication
(10) Pub. No.: US 2021/0133760 A1
(43) Pub. Date: May 6, 2021

(54) MULTI-FACTOR AUTHENTICATION FOR BUSINESS TO CONSUMER TRANSACTIONS

(71) Applicant: salesforce.com, inc., San Francisco, CA (US)

(72) Inventor: Eugene Lee Lew, Olney, MD (US)

(21) Appl. No.: 16/670,164

(22) Filed: Oct. 31, 2019

(51) Int. Cl. G06Q 20/42; G06Q 20/40; G06Q 20/38

(52) U.S. Cl. CPC G06Q 20/425; G06Q 20/4014; G06Q 2220/00; G06Q 20/3829; G06Q 20/385

(57) ABSTRACT

A computing system can provide multi-factor authentication. In the system, a second entity can receive a request from a first entity via a network to transfer a user transaction from the second entity to the first entity. The system can extract a user ID from the request. The user ID can be linked to an identity of the user in a computerized user management system of the first entity. The system can determine that the user ID is valid and assigned to a user. The system can determine that the user is authorized to transfer the transaction to the first entity and cause a code to be provided to the second entity and to the user in response. The system can receive an indication that the second entity confirmed receipt of the code by the user and receive the user transaction at the first entity in response.

### BACKGROUND

Some businesses, such as hotels, may allow its customers to defer immediate payment for various additional goods and services. Instead, these supplementary purchases, known as “incidental” charges, may be appended to the customer's final bill and reconciled when the customer checks out of the hotel or at an otherwise later time.

For example, to defer payment for an incidental purchase, a hotel guest may provide his or her room number, which may be associated with an open account during the period of his or her stay. This may relieve the guest of having to carry cash or credit cards and may be particularly convenient where doing so would be impractical, such as while ordering at a swim-up pool bar. As long as the guests correctly provide their room number, the hotel can keep accurate records of purchases and calculate the incurred incidental charges during checkout.

### BRIEF SUMMARY

According to an embodiment of the disclosed subject matter a computer-implemented method for providing multi-factor authentication may include receiving, by a first entity, a request from a second entity via a network to transfer a user transaction from the second entity to the first entity. The method may further include extracting, using a processor, a user ID from the request, the user ID linked to an identity of the user in a computerized user management system of the first entity. The method may further include determining, using the processor, that the user ID is valid and assigned to a user in the computerized user management system. The method may further include determining, based on authorization information in the computerized user management system, that the user is authorized to transfer the transaction to the first entity. In response to determining that the user ID may be valid and that the user may be authorized to transfer the transaction to the first entity, the method may further include causing a code to be provided to the second entity and to the user. The method may further include receiving, from the second entity, an indication that the second entity confirmed receipt of the code by the user. Responsive to receiving the indication that the first entity confirmed receipt of the code by the user, the method may further include receiving the user transaction at the first entity. The code may be uniquely generated based on a first entity ID and a second entity ID. The first entity ID and the second entity ID may uniquely identify the first entity and the second entity, respectively. The method may further include encrypting, using the processor, the first entity ID and the second entity ID using a private key of the second entity or a public key of a third entity. The indication may be received based on performing a comparison between the code received by the user and a code received by the second entity. The code may be generated by a third entity located remote from the first entity and the second entity. The code may be generated by the first entity. The third entity may comprise an electronic computing platform that stores customer records of each of the first entity and the second entity. The step of causing the code to be provided to the first entity and the user may further include sending a request for the code to the third entity. The method may further include receiving user data provided by the user and comparing the user data with pre-existing data associated with the user ID. A first identity that may identify the first entity may be concealed from the second entity. Aa second identity that may identify the second entity may be concealed from the first entity. The method may further include cross-examining, using the processor, a first data object associated with the user ID and stored in a data store of the second entity with a corresponding second data object associated with the user ID and stored in a data store of a third entity. The method may further include rejecting, using the processor, the request to transfer the transaction based on identifying a transaction type parameter of the request that is prohibited by the first entity or prohibited by the user. The code may be received by a personal computing device in possession of the user.

According to an embodiment of the disclosed subject matter a system for providing multi-factor authentication may include a processor and a memory in communication with the processor. The memory may store a plurality of instructions executable by the processor to cause the system to receive, by a first entity, a request from a second entity via a network to transfer a user transaction from the second entity to the first entity. The plurality of instructions may further include instructions to cause the system to extract, using the processor, a user ID from the request, the user ID linked to an identity of the user in a computerized user management system of the first entity. The plurality of instructions may further include instructions to cause the system to determine, using the processor, that the user ID is valid and assigned to a user in the computerized user management system. The plurality of instructions may further include instructions to cause the system to determine, based on authorization information in the computerized user management system, that the user is authorized to transfer the transaction to the first entity. In response to determining that the user ID may be valid and that the user may be authorized to transfer the transaction to the first entity, the plurality of instructions may further include instructions to cause the system to cause a code to be provided to the second entity and to the user. The plurality of instructions may further include instructions to cause the system to receive, from the second entity, an indication that the second entity confirmed receipt of the code by the user. Responsive to receiving the indication that the first entity confirmed receipt of the code by the user, the plurality of instructions may further include instructions to cause the system to receive the user transaction at the first entity. The code may be uniquely generated based on a first entity ID and a second entity ID. The first entity ID and the second entity ID may uniquely identify the first entity and the second entity, respectively. The plurality of instructions may further include instructions to cause the system to encrypt, using the processor, the first entity ID and the second entity ID using a private key of the second entity or a public key of a third entity. The indication may be received based on performing a comparison between the code received by the user and a code received by the second entity. The code may be generated by a third entity located remote from the first entity and the second entity. The code may be generated by the first entity. The third entity may comprise an electronic computing platform that stores customer records of each of the first entity and the second entity. The step of causing the code to be provided to the first entity and the user may further include sending a request for the code to the third entity. The plurality of instructions may further include instructions to cause the system to receive user data provided by the user and comparing the user data with pre-existing data associated with the user ID. A first identity that may identify the first entity may be concealed from the second entity. Aa second identity that may identify the second entity may be concealed from the first entity. The plurality of instructions may further include instructions to cause the system to cross-examine, using the processor, a first data object associated with the user ID and stored in a data store of the second entity with a corresponding second data object associated with the user ID and stored in a data store of a third entity. The plurality of instructions may further include instructions to cause the system to reject, using the processor, the request to transfer the transaction based on identifying a transaction type parameter of the request that is prohibited by the first entity or prohibited by the user. The code may be received by a personal computing device in possession of the user.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A illustrates an example of a multi-tenant environment according to an embodiment of the disclosed subject matter.

FIG. 1B illustrates an example of a multi-tenant environment according to an embodiment of the disclosed subject matter.

FIG. 2A illustrates a swim-lane diagram for providing a multi-factor authentication technique according to an embodiment of the disclosed subject matter.

FIG. 2B illustrates a swim-lane diagram for providing a multi-factor authentication technique according to an embodiment of the disclosed subject matter.

FIG. 3 illustrates a flow diagram of a method for providing multi-factor authentication according to an embodiment of the disclosed subject matter.

FIG. 4 illustrates a computing device according to an embodiment of the disclosed subject matter.

FIG. 5 illustrates a network configuration according to an embodiment of the disclosed subject matter.

FIG. 6 illustrates an example network and system configuration according to an embodiment of the disclosed subject matter

### DETAILED DESCRIPTION

To facilitate understanding of the present subject matter by example, the subsequent discussion will describe an example scenario where a user requests to transfer a restaurant transaction and the associated charges to an open account at a hotel where he or she may be staying. It should be appreciated that the hotel and the restaurant are merely example business entities and may be substituted with any type of business entity that participates in transactions, such as kiosks, retail stores, gyms, spas, fuel stations, other points-of-sale, and the like.

As previously discussed, a hotel may allow its guests to defer immediate payment for incidental charges by providing a name or room number. Hotel personnel may use this information to reference an existing, open, guest account to which the incidental charges may be applied. A guest may make payment for the incidental charges during check-out or other convenient time.

While the aforementioned process may usually be successful, there are scenarios that may render the hotel vulnerable to non-payment for these incidental charges. For example, the person incurring the incidental charges may, either accidentally or intentionally, provide the wrong room number to a hotel employee. In another example, a hotel employee may incorrectly record the room number. In either of these cases, when a hotel guest disputes the incidental charges, the hotel may withdraw the charges since it may have no way to determine the identity of the person who actually incurred them. Even where signatures are used when signing for incidental goods and services, the signatures are often ineffective in proving identity as a result of being illegible or signed under a fraudulent name.

The present subject matter discloses a computer-implemented method and system that may allow a user to transfer a transaction from a first business entity, such as a restaurant, to a second business entity, such as a hotel. The disclosed method and system may allow for authenticating the identity of the user with increased certainty when compared with conventional approaches. The disclosed method and system may also be more convenient in that the user may transact with a variety of businesses, and all charges may appear on a consolidated bill at a business entity that the user chooses. The chosen business entity may have an existing relationship with the user, such as a membership or loyalty account, and forwarding transactions to the chosen business entity may allow the user to accumulate reward points or other incentives and forms of compensation. The present subject matter may be implemented within a multi-tenant cloud-based architecture, where each of the first and second entities may be tenants. A multi-tenant cloud-based architecture may facilitate the sharing of applications and services between tenants, as well as providing identity verification of a user based on data associated with the user stored across multiple tenants.

The term “tenant” as used herein refers to one or more entities, where each entity may be user, a group of users, a website, a mobile application, an e-commerce store, an API, or the like. One or more entities within a tenant may share common data, stored in a database, with the other entities within that same tenant. Tenants may be representative of customers, customer departments, business or legal organizations, or other groups that maintain data for sets of users within the system. Although multiple tenants may share access to system resources, processing spaces, and data stores, the data and services provided to each tenant may be securely isolated from the data and services provided to other tenants. In this way, the multi-tenant system may allow different sets of entities to share functionality without necessarily sharing any data.

In an embodiment, the entities described in the present subject matter are business entities, such as hotels, restaurants, kiosks, retail stores, fuel stations, convenience stores, gyms, spas, points-of-sale, and the like. It should be appreciated that the disclosed subject matter may be equally applicable to other types of entities as previously described. The entities may be tenants of a multi-tenant cloud-based architecture. The disclosed techniques may also be implemented in the context of various other database systems, such as cloud-based systems that are not part of a multi-tenant database system. In addition, each “entity” disclosed herein may be any business, corporate, or individual entity that provides goods or services to users, which may or may not be linked to other such entities via a third-party infrastructure such as a multi-tenant cloud-based architecture. Accordingly, although described with respect to specific embodiments and entity types for clarity and ease of understanding, the methods and systems disclosed herein may be applicable to any general provider of goods and/or services, and any relationship among two or more such entities that may provide goods and/or services to common users.

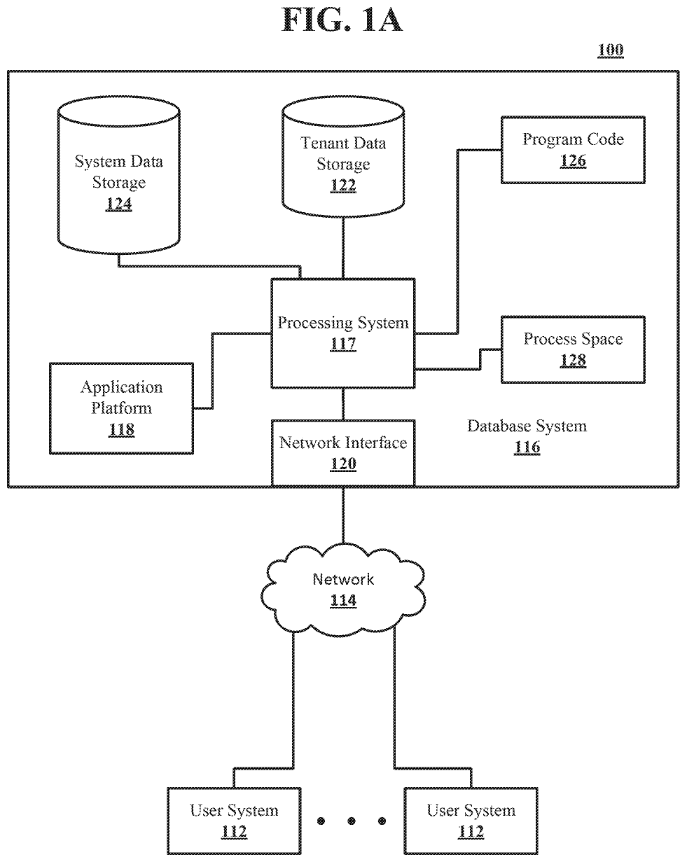

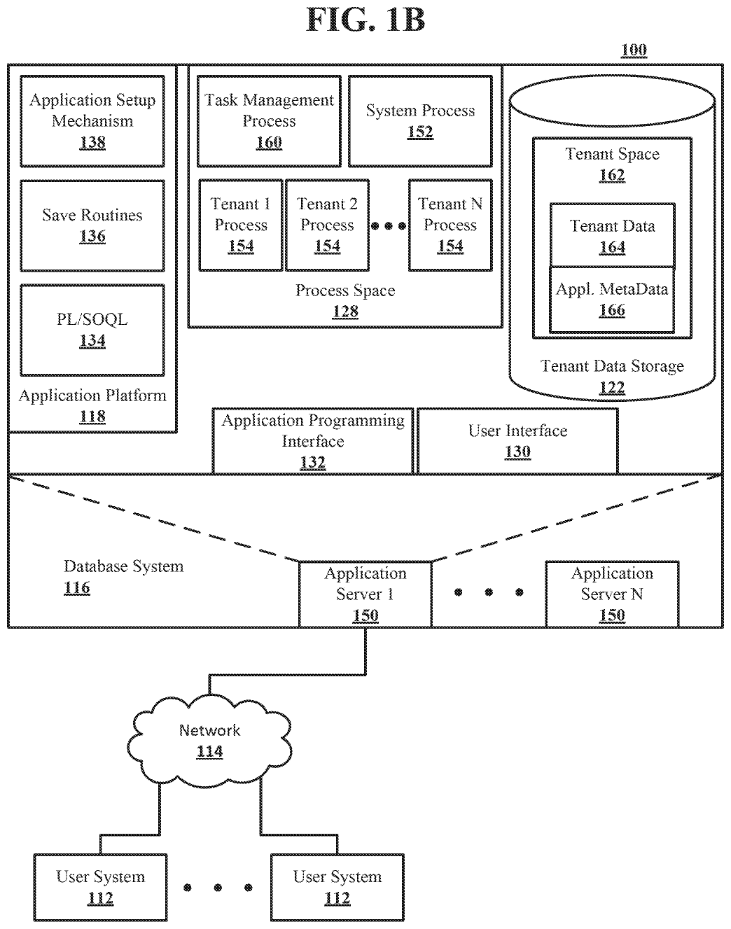

FIG. 1A shows a block diagram of an example of a multi-tenant environment 100. The multi-tenant environment 100 may include user systems 112, a network 114, a cloud-based database system 116, a processing system 117, an application platform 118, a network interface 120, tenant database 122 for storing tenant data, system database 24 for storing system data, program code 126 for implementing various functions of the database system 116, and process space 128 for executing database system processes and tenant-specific processes, such as running applications as part of an application hosting service. Multi-tenant environment 100 may not have all of the aforementioned components and systems, or may have other components and systems instead of, or in addition to, those listed above. In an embodiment, an on-demand database service may exist within multi-tenant environment 100.

An on-demand database service, which may be implemented using database system 116, as used herein refers to a service that is made available to users outside of the entities that own, maintain, or provide access to the database system 116. The users of an on-demand database service may not generally be concerned with constructing or maintaining the database system 116. Instead, resources provided by the database system 116 may be available for use when the users request various services provided by the system 16 upon the demand of the users.

Some on-demand database services may store information from one or more tenants into tables of a common database image to form a multi-tenant database system. The term “multi-tenant database system,” as used herein refers to those systems in which various elements of hardware and software of a database system may be shared by one or more customers or tenants. For example, a given application server may simultaneously process requests for several tenants, and a given database table may store rows of data for a potentially much greater number of tenants.

Application platform 118 may be a framework that allows the applications of database system 116 to execute, such as the hardware or software infrastructure of the database system 116. The application platform 118 may enable the creation, management, and execution of one or more applications developed by the provider of the on-demand database service, users accessing the on-demand database service via user systems 112, or third party application developers accessing the on-demand database service via user systems 112.

Database system 116 may implement a web-based customer relationship management (CRM) system. For example, the database system 116 may include application servers configured to implement and execute CRM software applications and may provide related data, code, forms, web pages, documents, and other information between user systems 112, and store and retrieve from database system related data, objects, and web content. The data assigned to the virtual computing environment for each tenant of the multiple tenants may be stored in the same physical data storage device in tenant data storage 122. Tenant data may be arranged in the tenant data storage 122 such that data of one tenant is kept logically separate from the data of other tenants, so that one tenant may not have access to another tenant's data. The database system 116 may also implement applications other than, or in addition to, a CRM application. For example, the database system 116 may provide tenant access to multiple hosted applications, such as a gaming or sports-betting application. Third-party developer applications, which may or may not include CRM, may be supported by the application platform 118. Application platform 118 may manage the creation and storage of the applications into one or more database objects and the execution of the applications in one or more virtual machines of the process space of the database system 116.

In an embodiment, database system 116 is configured to provide web pages, forms, applications, data and media content to user systems 112 to support access by user systems 12 as tenants of database system 116. As such, database system 116 may provide security mechanisms to keep each tenant's data isolated from the data of all other tenants. If more than one multi-tenant system is used, they may be in close proximity to one another, for example, in a server farm located in a single building, or they may be distributed at locations relatively remote from one another. Each multi-tenant system may include one or more logically or physically-connected servers distributed locally or across one or more geographic locations. The term “server,” as used herein refers to a computing device or system, including processing hardware and process space, an associated storage medium, such as a memory device or database, and in some instances, a database application. It should also be understood that the database objects described herein may be implemented as part of a single database, a distributed database, a collection of distributed data bases, a database with redundant online or offline backups, or other redundancies and may include a distributed database or storage network with an associated processing capability.

The network 114 may be or include any network or combination of networks of systems or devices that communicate with one another. For example, the network 114 may be or include any one or any combination of a LAN (local area network), WAN (wide area network), telephone network, wireless network, cellular network, point-to-point network, star network, token ring network, hub network, and the like. The network 114 may include a TCP/IP (Transfer Control Protocol and Internet Protocol) network, such as the Internet. It should be understood that the networks that the disclosed implementations may use are not so limited.

The user systems 112 may communicate with database system 116 using TCP/IP and at a higher network level, other Internet protocols, such as HTTP, FTP, AFS, WAP, etc. In an example where HTTP is used, each user system 112 may include an HTTP client, such as a web browser for sending and receiving HTTP signals to and from an HTTP server of the database system 116. Such an HTTP server may be implemented as the sole network interface 120 between the database system 116 and the network 114. In an embodiment, the network interface 120 between the database system 116 and the network 114 may include load sharing functionality, such as round-robin HTTP request distributors to balance loads and distribute incoming HTTP requests evenly over several servers.

Each user system 112 may execute an HTTP client, for example, a web browser application. Each user system 112 also may include one or more user input devices for interacting with a graphical user interface (GUI) provided by the browser on a display of the user system 112 in conjunction with pages, forms, applications and other information provided by the database system 116 or other systems or servers. For example, the user interface device may be used to access data and applications hosted by database system 116, and to perform searches on stored data, and otherwise allow a user to interact with various GUI pages that may be presented to a user.

The users of user systems 112 may differ in their respective capacities, and the capacity of a user system 112 may be determined by permissions for the current user of such user system. For example, where a salesperson is using a user system 112 to interact with the database system 116, that user system 112 may have the capacities allotted to the salesperson. However, while an administrator may be using that user system 112 to interact with the database system 116, that user system 112 may have the capacities allotted to that administrator. Where a hierarchical role model may be used, users at one permission level may have access to applications, data, and database information accessible by a lower permission level user, but may not have access to certain applications, database information, and data accessible by a user at a higher permission level. Therefore, different users may generally have different capabilities in terms of accessing and modifying application and database information, depending on the users' respective security permissions.

FIG. 1B shows a block diagram of an embodiment of several of the elements of FIG. 1A with additional detail. As shown in FIG. 1B, the network interface 120 may be implemented as a set of HTTP application servers 150. Each of the application servers 150 may be configured to communicate with tenant data storage 122 and the tenant data therein, as well as system data storage 124 and the system data therein, to serve requests received from the user systems 112. The tenant data may be divided into individual tenant storage spaces 162, which may be physically or logically arranged or divided. Within each tenant storage space 162, user storage 164 and application metadata 166 may be similarly allocated for each user. For example, a copy of a user's most recently used (MRU) items may be stored to user storage 164. Similarly, a copy of MRU items for an entire organization forming a tenant may be stored in tenant storage space 162.

The process space 128 may include a system process space 152, individual tenant process spaces 154, and a task management process space 160. The application platform 118 may include an application setup mechanism 138 that may support application developers' creation and management of applications. Such applications and others may be saved as metadata into tenant data storage 122 by save routines 136 for execution by users as one or more tenant process spaces 154 managed by tenant management process 160, for example. Invocations to such applications may be coded using PL/SOQL 134, which may provide a programming language style interface extension to API 132. Invocations to applications may be detected by one or more system processes, which may manage retrieving application metadata 166 for the subscriber making the invocation and executing the metadata as an application in a virtual machine.

Each application server 150 may be communicably coupled with tenant database 122 and system database 14, for example, having access to tenant data and system data, respectively, via a different network connection. For example, one application server 150 may be coupled via the network 114, another application server 150 may be coupled via a direct network link, and another application server 150 may be coupled by yet a different network connection.

Each application server 150 may be configured to handle requests for any user associated with any organization that is a tenant of the database system 116. Application servers 150 may be added and removed from the server pool at any time and any reason. In an embodiment, there may be no server affinity for a user or organization to a specific application server 150. An interface system implementing a load balancing function may be communicably coupled between the application servers 150 and the user systems 112 to distribute requests to the application servers 150. In an example, the load balancer uses a least-connections algorithm to route user requests to the application servers 150. Other examples of load balancing algorithms, such as round robin and observed-response-time, may also be used. In an example, database system 116 may be a multi-tenant system that handles storage and access to different objects, data, and applications across disparate users and organizations.

In an example, one tenant may be a company that employs a sales team where each salesperson may use database system 116 to manage various aspects of their sales. A user may maintain contact data, leads data, customer follow-up data, performance data, goals and progress data in tenant data storage 122. In another example, because all the data and applications may be maintained and accessed by a user system 112 having little more than network access, the user may manage his or her sales efforts and cycles from any of the multiple user systems 112.

While each user's data may be stored separately from other users' data regardless of the associated organizations of each user, some data may be shared across throughout the organization or may be accessible by several users of all the users for a given organization that forms a tenant. Thus, some data structures managed by database system 116 may be allocated at the tenant level while other data structures may be managed at the user level. Because a multi-tenant system may support multiple tenants including possible competitors, the multi-tenant system may have security protocols that keep data, applications, and application use separate. Some tenants may opt for access to a multi-tenant system rather than maintain their own system. The multi-tenant system may provide greater redundancy, uptime, and backup storage with lower overhead and at a lower cost. In addition to user-specific data and tenant-specific data, the database system 116 may also maintain system-level data usable by multiple tenants or other data. System-level data may include industry reports, news, postings, and the like that are sharable among tenants.

The user systems 112 may communicate with the application servers 150 to request and update system-level and tenant-level data from the database system 116. Such requests and updates may involve sending one or more queries to tenant database 122 or system database 124. Application server 150 may automatically generate one or more SQL statements designed to access the desired information. System data storage 124 may generate queries to access the requested data from the database.

Each database may generally be viewed as a collection of objects, such as a set of logical tables, containing data fitted into predefined or customizable categories. A “table” as used herein refers to one representation of a data object and may be used to simplify the conceptual description of objects and custom objects. Each table may generally contain one or more data categories logically arranged as columns or fields in a viewable schema. Each row or element of a table may contain an instance of data for each category defined by the fields. For example, a CRM database may include a table that describes a customer with fields for basic contact information, such as name, address, phone number, fax number, etc. Another table may describe a purchase order, including fields for information such as customer, product, sale price, date, etc. In some multi-tenant system embodiments, standard entity tables may be provided for use by all tenants. For CRM database applications, such standard entities may include tables for case, account, contact, lead, and opportunity data objects, each containing pre-defined fields.

In some multi-tenant system embodiments, tenants may be allowed to create and store custom objects or may be allowed to customize standard entities or objects, for example by creating custom fields and indexes for standard objects. In an example, all custom entity data rows may be stored in a single multi-tenant physical table, which may contain multiple logical tables per organization. It may be transparent to users that their multiple “tables’ may be stored in one large table or that their data may be stored in the same table as the data of other users.

A “record,” as used herein refers to a data entity, such as an instance of a data object created by a user or a group of users of the database system 116. Each record may be identified by a record identifier that may be unique at least within the respective organization. Such records may include, for example, data objects representing and maintaining data for accounts. Each record may be assigned to a record type. Examples of account record types may include: customers, customer support, households, partners, suppliers, and other organizations. Other examples of record types may include cases, opportunities, leads, projects, contracts, orders, price books, products, solutions, reports and forecasts, among other possibilities. As another example, a record such as an account record itself may include a number of records. For example, a customer account may include opportunities, contracts, and orders. A record may also include various data fields and controls that are defined by the structure or layout of the object. A record may also have custom fields defined by a user or organization. A field may include, or include a link to, another record, thereby providing a parent-child relationship between the records.

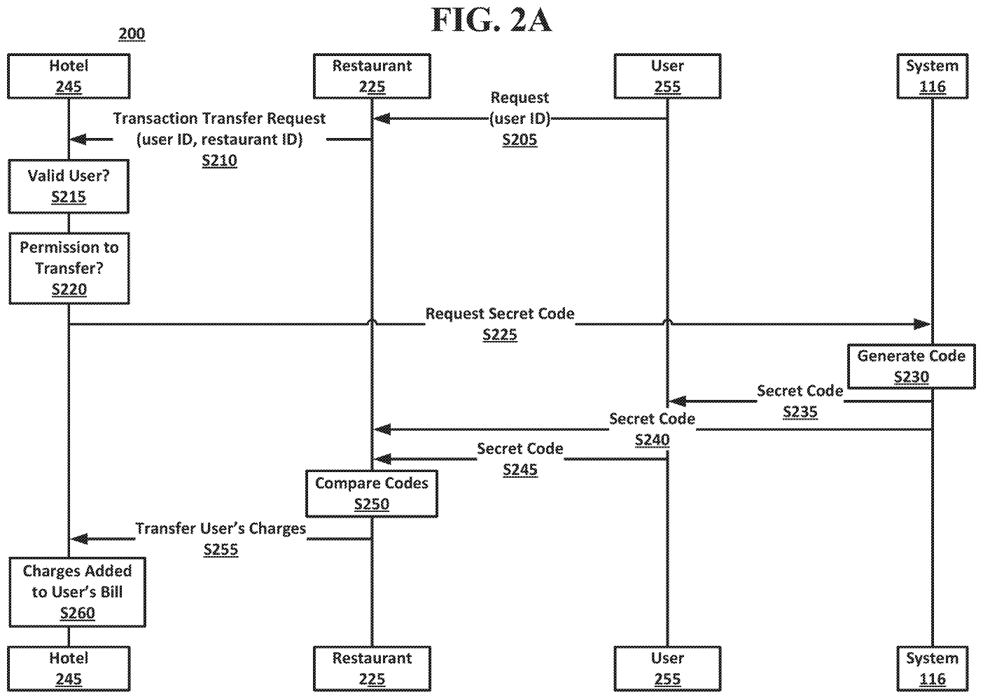

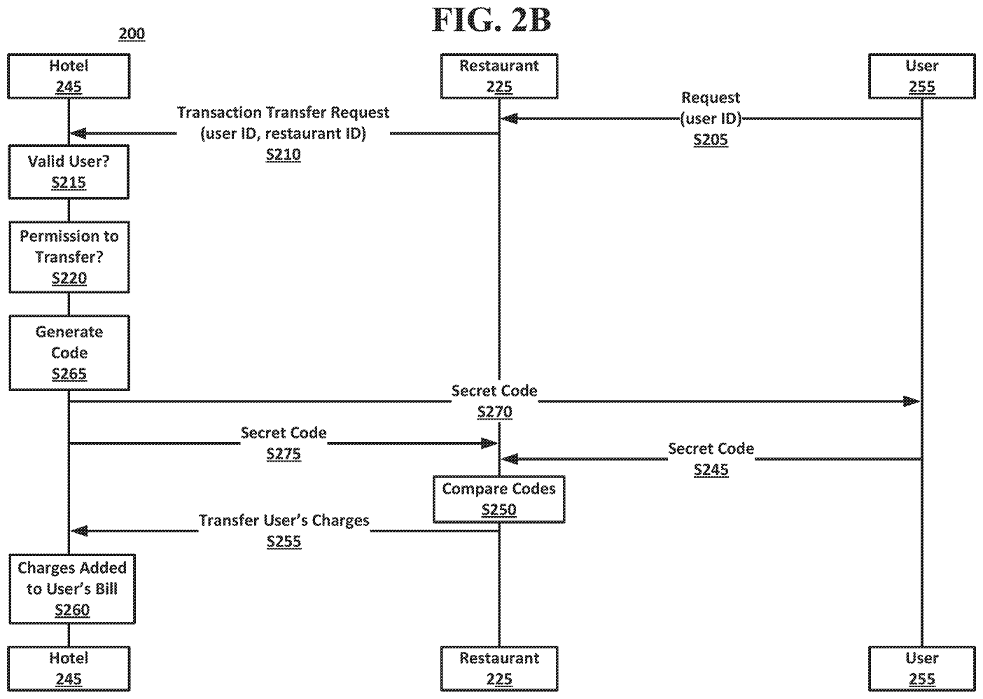

FIG. 2A is a “swim-lane” diagram illustrating a technique 200 to transfer a transaction from a first business entity to a second business entity. To facilitate understanding of the present subject matter, the subsequent discussion will describe an example scenario where a user 255 requests to transfer a restaurant 225 transaction and associated charges to an open account at a hotel 245. One or both of restaurant 225 and hotel 245 may be tenants of the multi-tenant environment 100, each sharing access to system 116, including but not limited to the processing space(s) 128 and data storage 122. It should be appreciated that hotel 245 and restaurant 225 are merely example business entities and may be substituted with any type of business entity that participates in transactions, such as kiosks, retail stores, gyms, spas, fuel stations, other points-of-sale, and the like.

A user 255 may conduct business transactions at a first entity, such as restaurant 225, by placing orders for food and drink, for example. When presented with the bill for these items, the user 255 may wish defer payment and instead transfer the transaction and the billed charges to a second entity, such as hotel 245. For example, the user may be currently staying at hotel 245 and have an open account where incidentals and the like may be charged and paid for at a later time.

To make a request to transfer the restaurant 225 charges, user 255 may present a user identification in S205. The user identification may be presented in a variety of ways. For example, the user 255 may verbally communicate his or her name, a hotel room number, a social security number, a driver's license, a passport, and the like. Alternatively, or in addition, the user 255 may enter a pin number, password, or sign his or her signature on a computing device of the restaurant 225. Alternatively, or in addition, the user 255 may present his or her fingerprint or other biometric, credit card or EMV card, driver's license, passport, social security card, RFID card, coupon, certificate, and the like. The user 255 may also present an identifying object issued by the hotel 245, such as a room key or key fob, ID card, RFID card, membership card, and the like.

The restaurant 225 may, with or without the use of a computing device, use any of the aforementioned forms of identification to make an inquiry into a data store, such as within its assigned tenant space 162 to determine whether additional information is known about user 255. The restaurant 225 may store customer records within its assigned tenant space 162, which may be located within database system 116 as shown in FIG. 1B. Additional information, if previously stored, may provide an additional basis for verifying that the user's 255 identity as a prerequisite to sending the charge transfer request in S210. For example, where the restaurant's 225 data store may include items of information that only user 255 would know, such as a zip code, birth date, mobile phone number, and the like, the restaurant 225 may prompt the user 255 to provide one or more of these items of information via a personal computing device, restaurant computing device, restaurant personnel, or the like.

At any point during technique 200, an entity, such as hotel 245 or restaurant 225, may request additional identity verification from database system 116. Database system 116 may be a component of multi-tenant environment 100, for which one or more of hotel 245, restaurant 225, and other business entities may be tenants. As previously discussed, data and services provided to one tenant may be securely isolated from the data and services provided to other tenants. On the other hand, database system 116 may act as a neutral arbitrator by cross-examining user 255 data across the tenant data stores of one or more tenant entities for identity verification purposes. A tenant data store may be tenant space 162, for example. In an example, restaurant 225 may receive a user's 255 request to transfer a transaction to another entity but would prefer to get further identity verification assistance from database system 116. Where restaurant 225 may be a tenant of multi-tenant environment 100, database system 116 may compare user 255 data stored within the restaurant's 225 tenant space 162 with pre-existing corresponding user 255 data stored in other tenant entities' tenant spaces 162. In an example, restaurant 225 may store within its tenant space 162 a plurality of data objects associated with user 255, such as the user's 255 name, address, and phone number, and other customer records. Upon making a request for verification assistance, database system 116 may compare the restaurant's 225 name, address, and phone number of user 255, or as referenced by the user ID, with any preexisting and corresponding user 255 data stored in the tenant spaces 162 of tenant business entities X, Y, and Z. For example, database system 116 may reference the user ID of user 255 to compare a surname data object in a data store of the restaurant 225 with a surname data object in a data store of a convenience store to determine whether a match exists. Consistencies between user 255 data across multiple tenant business entities may increase the trust that should be attributed to user 255, while inconsistencies and/or other types of data may decrease the trust that should be attributed to user 255. In an example, the examination of user 255 data across multiple tenant business entities X, Y, and Z may reveal that a user 255 has used several different aliases and wrote a series of bad checks. In this example, database system 116 may provide a low trust score to restaurant 225 without exposing the user 255 data sourced from tenant business entities X, Y, and Z upon which the low trust rating was based to restaurant 225.

Restaurant 225 may make a charge transfer request in S210 by including the user's 255 provided user ID and/or a restaurant ID to hotel 245. The business entity and/or business entity ID to which the user wishes to transfer the transaction including the charge, such as hotel 245, may be concealed from the restaurant 225 for user privacy reasons. All business entities may have an associated business entity ID, such as the restaurant ID or the hotel ID that may uniquely distinguish each business entity from another within system 100. In an example, the user may input the destination entity to which the restaurant charge should be transferred using his or her personal computing device, such as a smartphone. In an example, the user may input the destination business entity using a computing device of the restaurant via a software interface that prevents the viewing and storing of the destination business entity. The user ID may be encrypted using a public key of the hotel 245. The restaurant ID may be encrypted using a public key of the restaurant 225, thereby concealing the identity of restaurant 225 to the hotel 245. Alternatively, the restaurant ID may be signed using the private key of the restaurant 225 and encoded such that the restaurant ID is not directly identifiable by the hotel 245 without having knowledge of the encoding scheme. Upon receiving the transaction transfer request transmitted in S210, the hotel 245 may extract the user ID portion and use its private key to decrypt the user ID. The hotel 245 may then use the user ID to lookup the user 255 in a computerized user management system of the hotel 245. The computerized user management system may provide access a data store, such as within its assigned tenant space 162, to determine whether a valid account exists for that user 255 in S215. The hotel 245 may store customer records within the assigned tenant space 162, which may be located within database system 116 as shown in FIG. 1B. In an embodiment, the computerized user management system of hotel 245 may be a user system 112 or a component of a user system 112 of the multi-tenant environment 100. Alternatively, or in addition, an entity 245 may store customer records in its own computerized user management system that is separate and distinct from the database system 116. For example, a large hotel chain or other similar entity may maintain its own computerized user management system instead of or concurrently with a system provided and/or maintained by a third party. In such a configuration, the entity 245 may use the third party system to generate codes as disclosed herein, or it may generate codes separately using records of its own computerized user management system.

Hotel 245 may also store one or more permission parameters associated with one or more users within its associated data store of the computerized user management system that may be examined in S220. Permission parameters may configure whether a user 255 may be authorized to transfer transactions to and/or from hotel 245. Permission parameters may also include a list of entities to which hotel 245 may receive transferred transactions from and/or transfer transactions to. For example, an entity such as hotel 245 may set in its permission parameters that it may only receive transferred transactions from entities existing on a whitelist, types of entities, entities having a mutually-beneficial relationship with hotel 245, and the like. Permission parameters may be defined by users for subordinate users existing on a same shared account. A request to transfer a transaction may include a transaction type parameter that identifies the nature of the goods or services involved without identifying the entity from which the transaction is forwarded. For example, a parent user 255 may provide a child user with a hotel ID card that allows for transferring transactions from a book store but not a candy store. Similarly, the parent user 255 of a child in college may define permission parameters that allow for transferring transactions for food, textbook, and fuel purchases, but may prohibit alcohol and tobacco purchases.

In S225, hotel 245 may transmit a request for a secret code to database system 116, which may be a component of multi-tenant environment 100. The secret code request may include an encrypted restaurant ID and encrypted hotel ID using the public key of database system 116 or private key of the hotel 245. Alternatively, or in addition, the restaurant ID to be transmitted within the secret code request may be encrypted using one or more of the restaurant 225 private key, the restaurant 225 public key, the hotel 245 public key, and the database system 116 public key. The hotel ID to be transmitted may also be encrypted using the database system 116 public key, the hotel 245 public key, or the hotel 245 private key. Database system 116 may receive the request and generate a shared secret code in S230. The shared secret code may be based on the restaurant ID and the hotel ID, both of which may be decrypted by the database system 116 using one or more of the hotel private key, restaurant private key, hotel public key, restaurant public key, and database system 116 private key. In an embodiment, the shared secret code may be generated using a mathematical algorithm that combines the restaurant ID and the hotel ID.

Upon generation of the shared secret code in S230, the shared secret code may be transmitted to the user 255 in S235 and to the restaurant 225 in S240. The shared secret code may be transmitted to the user 255 and to restaurant 225 from database system 116 in any electronic manner, such as via e-mail, SMS/EMS/MMS messaging, text message, voice call, social media instant message, displayed on a website, software application, and the like. In an embodiment, the shared secret code transmitted in S235 may be encrypted the public key of the user 255 or the private key of the database 116. The shared secret code transmitted in S240 may be encrypted using the public key of the restaurant 225 or the private key of the database system 116. In response to receiving the shared secret code in S235, the user 255 may provide the shared secret code to the restaurant 225 in S245. The code may be provided from the user 255 to the restaurant 225 via directly input on a restaurant computing device, input through a website, software application, e-mail, SMS/EMS/MMS messaging, text message, voice call, social media instant message, or directly to restaurant 225 personnel through spoken words and/or writing. Upon receipt of the user's 255 shared secret code, in S250 restaurant 225 may compare its shared secret code received in S240 with the code provided by the user 255. Comparing the shared secret codes may be performed by a computing device of the restaurant 225 or by restaurant personnel. If the codes match, it may indicate that the user 255 who engaged in transacting business with restaurant 225 and who made the request to transfer the transaction in S205 does indeed possess an account at hotel 245 with appropriate permissions to transfer charges from other entities. In response to a successful comparison in S250, the restaurant 225 may transfer the user's 255 charges in S255 to hotel 245 as requested. Hotel 245 may receive the transferred transaction and associated charges in S260 and record them to the user's 255 hotel account.

Alternatively, or in addition, the shared secret code may be generated at hotel 245 in S265, as shown in FIG. 2B. As discussed with reference to FIG. 2A, the shared secret code may be based on the restaurant ID and the hotel ID. The restaurant ID may be encrypted using a private key of the restaurant 225 so that hotel 245 may verify its authenticity. Hotel 245 may then transmit the shared secret code to the user 255 in S270 and to the restaurant 225 in S275. The remaining steps shown in FIG. 2B, including S245, S250, S255, and S260 may be performed in a substantially similar manner as previously described with respect to FIG. 2A.

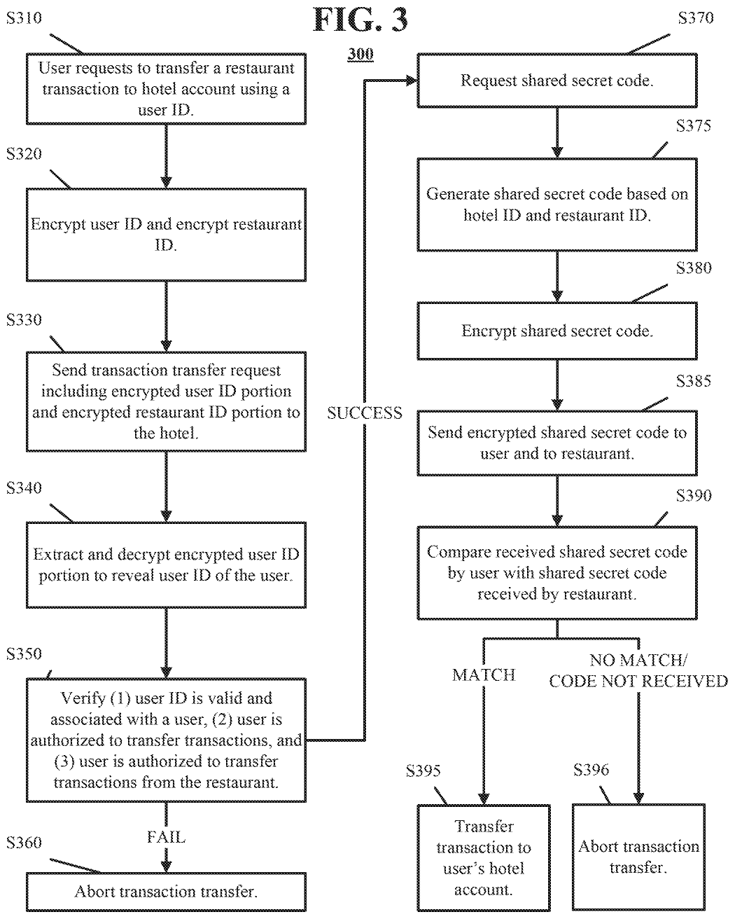

FIG. 3 is a flow diagram illustrating an example of a method 300 for transferring a transaction from a first entity to a second entity. As in the discussion of FIGS. 2A and 2B, the subsequent discussion with reference to FIG. 3 will describe an example scenario where a user 255 requests to transfer a restaurant 225 transaction and the associated charges to an account opened with a hotel 245. Method 300 may begin with a user 255 requesting to transfer a restaurant transaction to a hotel account in S310. The request may be made by providing a user identification. For example, user 255 may verbally communicate his or her name, a hotel room number, a social security number, a driver's license, a passport, and the like. Alternatively, or in addition, the user 255 may enter a pin number, password, or sign his or her signature. Alternatively, or in addition, the user 255 may present his or her fingerprint or other biometric, credit card or EMV card, driver's license, passport, social security card, RFID card, coupon, certificate, and the like. The user 255 may also present an identifying object issued by the hotel 245, such as a room key or key fob, ID card, RFID card, membership card, and the like.

In S320, the user ID provided by the user 255 may be encrypted using a public key of the hotel 245 or private key of the user 255. A restaurant ID corresponding to restaurant 225 may be encrypted using a public or private key of the restaurant 225, or a public key of the hotel 245, thereby concealing the identity of restaurant 225 to the hotel 245. Alternatively, or in addition, the restaurant ID may be encoded using an encoding scheme unknown to the hotel 245.

In S330, a transaction transfer request including the encrypted user ID and restaurant ID may be transmitted to the hotel. Upon receiving the transaction transfer request transmitted in S210, the hotel 245 may extract the user ID portion and use its private key to decrypt the user ID in S340. The hotel 245 may then make one or more of the following three determinations. The hotel may determine whether the user ID is valid and associated with a real user by using the user ID to look up user 255 in an associated data store of the hotel 245, such as within its assigned tenant space 162 or its own computerized user management system as previously disclosed, to determine whether a valid account exists for that user 255. A “valid” account may be, for example, a customer account that the entity 245 considers to be active, one for which a payment source such as a credit card is on file and available to receive charges from the entity 245, one that the entity 245 has previously validated according to its own rules and procedures, or the like. Similarly, the hotel 245 may determine whether the user 255 associated with the user ID is authorized to transfer transactions to the hotel 245 by examining one or more permission parameters. The hotel 245 may also determine whether the user 255 is authorized to transfer transactions from the restaurant 225. For example, an entity such as hotel 245 may set in its permission parameters that it may only receive transferred transactions from entities existing on a whitelist, entities of a particular type, entities having a mutually-beneficial relationship with hotel 245, and the like. Should any of these determinations fail, the transaction transfer may be aborted in S360.

Provided that the determinations were successful in S350, hotel 245 may transmit a request for a shared secret code in S370 to database system 116, which may be a component of multi-tenant environment 100. The secret code request may include the encrypted restaurant ID and/or the hotel ID. The hotel ID may be encrypted using a public key of database system 116 or a private key of the hotel 245. Database system 116 may receive the request and generate a shared secret code in S375. As previously discussed with respect to S265 of FIG. 2B, the shared secret code may alternatively or additionally be generated by hotel 245 and sent to the user and restaurant from hotel 245. The shared secret code may be based on the restaurant ID and the hotel ID, both of which may be decrypted by the database system 116 using one or more of the hotel private key, restaurant private key, and database system 116 private key. In an embodiment, the shared secret code may be generated using a mathematical algorithm that combines the restaurant ID and the hotel ID. In S380, database system 116 may encrypt the shared secret code to be transmitted to the user 255 using the public key of the user 255 or the private key of the database 116. Database system 116 may additionally encrypt the shared secret code to be transmitted to the restaurant 225 using the public key of the restaurant 225 or the private key of the database system 116.

In S385, the encrypted shared secret code may be transmitted to the user 255 and to restaurant 225 from database system 116 in any electronic manner, such as via e-mail, SMS/EMS/MMS messaging, text message, voice call, social media instant message, displayed on a website, software application, and the like.

In response to receiving the shared secret code transmitted in S385, the user 255 may provide the shared secret code to the restaurant 225. The code may be provided from the user 255 to the restaurant 225 via directly input on a restaurant computing device, input through a website, software application, e-mail, SMS/EMS/MMS messaging, text message, voice call, social media instant message, or directly to restaurant 225 personnel through spoken words and/or writing. Upon receipt of the user's 255 shared secret code, in S390 restaurant 225 may compare its shared secret code received in S240 with the code provided by the user 255. Comparing the shared secret codes may be performed by a computing device of the restaurant 225 or by restaurant personnel. A match may indicate that the user 255 is successfully authenticated and authorized to transfer the transaction from the restaurant 225 to the hotel 245. Following a match, the restaurant 225 may transfer the transaction and associated charges to hotel 245 in S395, where the transaction and charges may be recorded on the user's 255 hotel account. Conversely, where the user 255 is unable to provide a shared secret code or a non-matching code, the process 300 may abort the transaction transfer in S396.

Embodiments disclosed herein may allow for improving the security of transactions between business entities when transferring and forwarding charges between them. In this way, business entities may be able to provide the conveniences of deferred payment that users appreciate without incurring an unreasonable level of risk of nonpayment. This is due to the use of the disclosed authorization and authentication techniques which may be more effective when used within a multi-tenant environment.

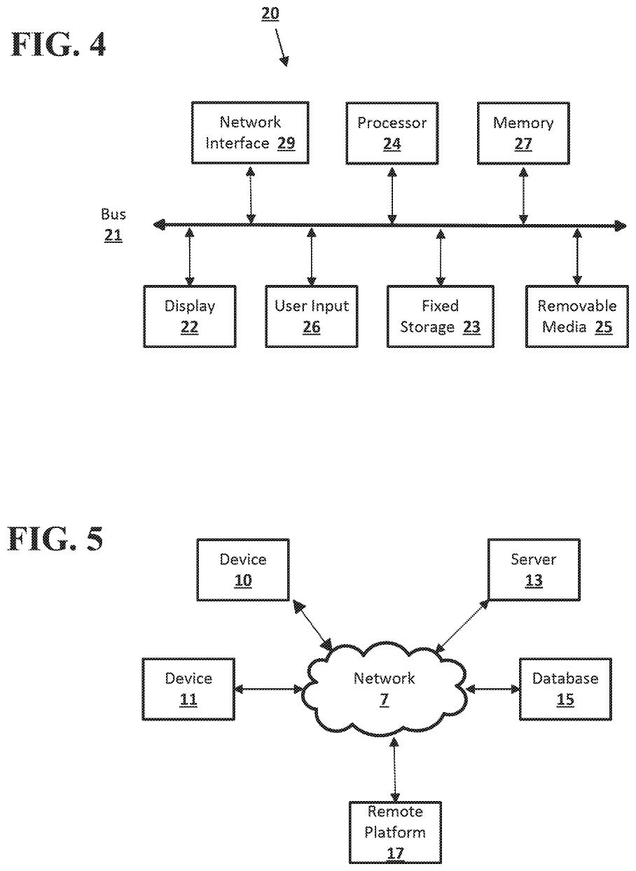

Embodiments of the presently disclosed subject matter may be implemented in and used with a variety of component and network architectures. FIG. 4 is an example computing device 20 suitable for implementing embodiments of the presently disclosed subject matter. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically, RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth(R), near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

FIG. 5 shows an example network arrangement according to an embodiment of the disclosed subject matter. One or more devices 10, 11, such as local computers, smart phones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

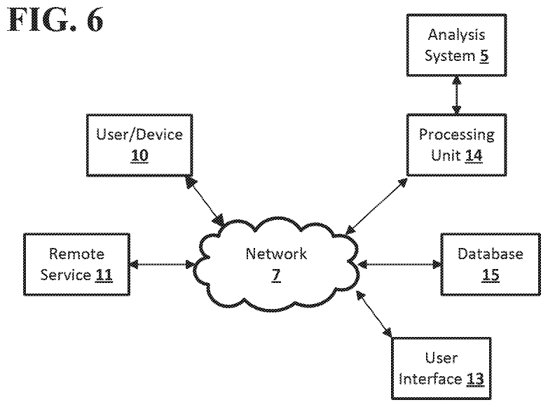

FIG. 6 shows an example arrangement according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method comprising:
receiving, by a first entity, a request from a second entity via a network to transfer a user transaction from the second entity to the first entity;
extracting, using a processor, a user ID from the request, the user ID linked to an identity of the user in a computerized user management system of the first entity;
determining, using the processor, that the user ID is valid and assigned to a user in the computerized user management system;
determining, based on authorization information in the computerized user management system, that the user is authorized to transfer the transaction to the first entity;
in response to determining that the user ID is valid and that the user is authorized to transfer the transaction to the first entity, causing a code to be provided to the second entity and to the user;
receiving, from the second entity, an indication that the second entity confirmed receipt of the code by the user; and
responsive to receiving the indication that the first entity confirmed receipt of the code by the user, receiving the user transaction at the first entity.

2. The method of claim 1, wherein the code is uniquely generated based on a first entity ID and a second entity ID.

3. The method of claim 2, wherein the first entity ID and the second entity ID uniquely identify the first entity and the second entity, respectively.

4. The method of claim 2, further comprising:
encrypting, using the processor, the first entity ID and the second entity ID using a private key of the second entity or a public key of a third entity.

5. The method of claim 1, wherein the indication is received based on performing a comparison between the code received by the user and a code received by the second entity.

6. The method of claim 1, wherein the code is generated by a third entity located remote from the first entity and the second entity.

7. The method of claim 1, wherein the code is generated by the first entity.

8. The method of claim 6, wherein the third entity comprises an electronic computing platform that stores customer records of each of the first entity and the second entity.

9. The method of claim 6, wherein the step of causing the code to be provided to the first entity and the user further comprises sending a request for the code to the third entity.

10. The method of claim 1, further comprising:
receiving user data provided by the user; and
comparing the user data with pre-existing data associated with the user ID.

11. The method of claim 1, wherein a first identity that identifies the first entity is concealed from the second entity.

12. The method of claim 1, wherein a second identity that identifies the second entity is concealed from the first entity.

13. The method of claim 1, further comprising cross-examining, using the processor, a first data object associated with the user ID and stored in a data store of the second entity with a corresponding second data object associated with the user ID and stored in a data store of a third entity.

14. The method of claim 1, further comprising rejecting, using the processor, the request to transfer the transaction based on identifying a transaction type parameter of the request that is prohibited by the first entity or prohibited by the user.

15. The method of claim 1, wherein the code is received by a personal computing device in possession of the user.

16. A system for providing multi-factor authentication comprising:
a processor;
a memory in communication with the processor, the memory storing a plurality of instructions executable by the processor to cause the system to:
receive, by a first entity, a request from a second entity via a network to transfer a user transaction from the second entity to the first entity;
extract, using the processor, a user ID from the request, the user ID linked to an identity of the user in a computerized user management system of the first entity;
determine, using the processor, that the user ID is valid and assigned to a user in the computerized user management system;
determine, based on authorization information in the computerized user management system, that the user is authorized to transfer the transaction to the first entity;
in response to determining that the user ID is valid and that the user is authorized to transfer the transaction to the first entity, causing a code to be provided to the second entity and to the user;
receive, from the second entity, an indication that the second entity confirmed receipt of the code by the user; and
responsive to receiving the indication that the first entity confirmed receipt of the code by the user, receive the user transaction at the first entity.

17. The system of claim 16, wherein the code is uniquely generated based on a first entity ID and a second entity ID.

18. The system of claim 17, wherein the first entity ID and the second entity ID uniquely identify the first entity and the second entity, respectively.

19. The system of claim 17, further comprising instructions executable by the processor to cause the system to:
encrypt, using the processor, the first entity ID and the second entity ID using a private key of the second entity or a public key of a third entity.

20. The system of claim 16, wherein the indication is received based on performing a comparison between the code received by the user and a code received by the second entity.

21. The system of claim 16, wherein the code is generated by a third entity located remote from the first entity and the second entity.

22. The system of claim 16, wherein the code is generated by the first entity.

23. The system of claim 21, wherein the third entity comprises an electronic computing platform that stores customer records of each of the first entity and the second entity.

24. The system of claim 21, wherein the step of causing the code to be provided to the first entity and the user further comprises sending a request for the code to the third entity.

25. The system of claim 16, further comprising instructions executable by the processor to cause the system to:
receive user data provided by the user; and
compare the user data with pre-existing data associated with the user ID.

26. The system of claim 16, wherein a first identity that identifies the first entity is concealed from the second entity.

27. The system of claim 16, wherein a second identity that identifies the second entity is concealed from the first entity.

28. The system of claim 16, further comprising instructions executable by the processor to cause the system to cross-examine, using the processor, a first data object associated with the user ID and stored in a data store of the second entity with a corresponding second data object associated with the user ID and stored in a data store of a third entity.

29. The system of claim 16, further comprising instructions executable by the processor to cause the system to reject, using the processor, the request to transfer the transaction based on identifying a transaction type parameter of the request that is prohibited by the first entity or prohibited by the user.

30. The system of claim 16, wherein the code is received by a personal computing device in possession of the user.
